(19) United States
(12) Patent Application Publication
(10) Pub. No.: US 2013/0135265 A1
(43) Pub. Date: May 30, 2013

(54) DISPLAY MODE-BASED INPUT KEY FUNCTION REASSIGNMENT IN A COMMUNICATION DEVICE

(71) Applicants: Joseph W. Seuck, Tamarac, FL (US); Cindy-Kay H. Forsyth-Martinez, Plantation, FL (US); Ronald R. Smith, Parkland, FL (US)

(72) Inventors: Joseph W. Seuck, Tamarac, FL (US); Cindy-Kay H. Forsyth-Martinez, Plantation, FL (US); Ronald R. Smith, Parkland, FL (US)

(73) Assignee: MOTOROLA MOBILITY, INC., Libertyville, IL (US)

(21) Appl. No.: 13/307,360

(22) Filed: Nov. 30, 2011

(51) Int. Cl. G09G 5/00

(52) U.S. Cl. 345/204

(57) ABSTRACT

A communication device is disclosed. The device includes a transceiver coupled to a controller, and a display having a user interactive touch-interface. The controller is configured to control a first function of the device upon actuation of a first switch when the display is in a first state and to control a second function of the communication device in upon actuation of a second switch. The first switch is perceptible regardless of the state of the display, and second switch is perceptible when the display is in the first state but not the second state. The controller controls the second function in response to actuating the first switch when the display is in a second state.

### FIELD OF THE DISCLOSURE

The present disclosure relates generally to communication devices and more particularly to display mode-based input key function reassignment in a communication device.

### BACKGROUND

The user interface on communication devices like cellular telephones have evolved from basic alphanumeric mechanical keypads with a relatively small display to an interface embodied as a predominant display having a touch-activated user interface. To conserve battery power, the display in many devices having an evolved user interface transitions from an illuminated state to a non-illuminated state or sleep mode. The transition to the non-illuminated state may be prompted by a lack of user interaction therewith or by the execution of an application that does not require use of the display. In devices where the display includes a touch-activated input interface, the non-illuminated display must be re-activated before the user may provide an input thereto. To re-activate or re-illuminate the sleeping display, the user must generally perform some action like swipe or touch the display or some other key, e.g., a home button, wherein the interaction causes the display to transition from the sleep state to the illuminated state. The reactivation of a sleeping display however requires a finite amount of time, which retards the user's input to the device.

The various aspects, features and advantages of the invention will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 is a schematic block diagram of a communication device.

FIG. 2 is a schematic diagram of a process implemented in a communication device.

### DETAILED DESCRIPTION

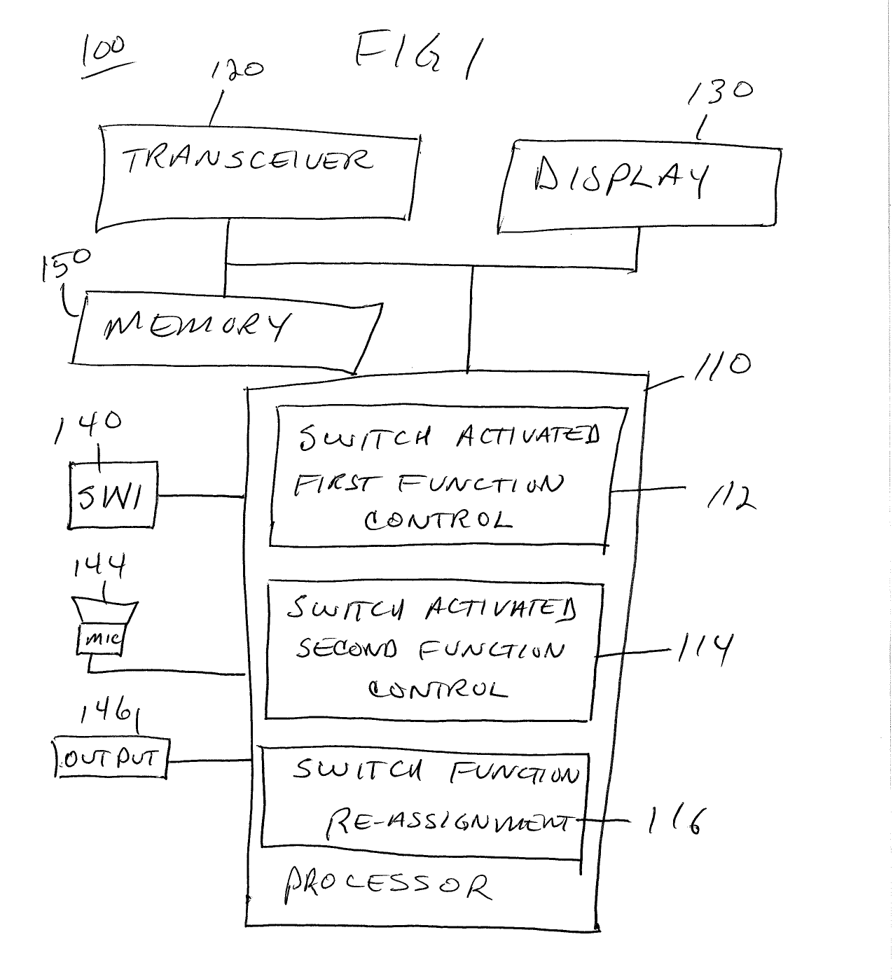

In FIG. 1, the communication device 100 comprises generally a controller 110 coupled to a transceiver 120 and to a display 130 having a user interactive touch-interface. The communication device may assume a variety of instantiations, non-limiting examples of which are described below. In one form, the communication device is embodied as a wireless communication device. For example, a cellular telephone, smart phone, satellite phone, a portable gaming or media device with wireless communication capabilities, or other handheld transceiver including a push-to-talk (PTT) device that communicates over a cellular network. The device could also be embodied as an intercom device, which may be a stand-alone device or integrated with another system like a phone system. The communication device may also be integrated into an appliance or industrial equipment. More generally, the communication device may be any wired or wireless communication device, fixed or portable.

In one implementation, the display transitions between states. In one embodiment, the display transitions between high and low power consumption modes. The low power consumption mode may be referred to as a sleep mode. In one particular embodiment, the transition is between an illuminated state and a non-illuminated state or at least a partially non-illuminated state. Such a transition may occur to reduce power consumption particularly in battery-powered devices, although power efficiency may also be desirable for devices connected to a power grid. Alternatively, the transition between modes may occur for reasons unrelated to reducing power consumption. For example, it may be desirable to eliminate or reduce illumination produced by the display or to increase operating life of the display or associated components, among other reasons. The transition to the non-illuminated state may be prompted by user interaction with the display interface or by a lack thereof, or by the execution of an application that does not require use of the display, among other reasons. These and other aspects of transitioning a display between illuminated and non-illuminated states are known generally to those having ordinary skill in the art and are not described further herein.

In another embodiment, the display transitions between states by presenting different visual information for interaction or consumption by the user. Some devices are capable of running multiple applications simultaneously wherein the display may present the user interface for one application while one or more other applications run in the background. For example, a first state of the display may include a visual interface for a first application and a second state of the display may include a visual interface for a second application, wherein the visual interface for the first application is not presented in the second state. The device may switch between user interfaces for different applications running simultaneously at the request of the user. Such discrete applications generally run on a common operating system like Android, Apple iOS, Microsoft Windows operating systems, among many other possible operating systems. These and other aspects of running multiple applications on a communication device and switching between the presentation of application interfaces on a display are well known to those having ordinary skill in the art and are not described further herein. In other embodiments, the communication device does not necessarily require a discrete communication application that runs on an operating system. For example, the communication device may switch between presenting different interfaces or menus on the display, wherein the different visual interfaces or menus are part of a monolithic operating system.

In one embodiment, the communication device includes a call mode or a communication application that runs on the operating system, for conducting circuit or packet communications from the device. Such a mode or application typically enables a user to select a communication address (e.g., a telephone number, Internet Protocol (IP) address, among others) from a directory and dial or otherwise initiate a connection to or with the address selected. According to this embodiment, upon invoking the communication mode or upon execution of the communication application, the user can initiate, manage and terminate communication sessions from the communication device using features and functions from a user interface presented on the display. Examples of features and functions that may be controlled or managed from a touch-activated interface associated with the communication application include, without limitation, volume control, enabling/disabling speaker phone mode, enabling/disabling mute mode, start/stop recording, among other features and functions many of which are well known to those having ordinary skill in the art. Some of these features and functions may also be controlled from or by mechanical interfaces on the communication device. For example, many communication devices include dedicated volume control buttons and key/buttons for inputting alpha-numeric text.

Some communication devices are capable of running multiple applications simultaneously. In such devices including a display having a touch-activated user interface, the user may configure the display to alternate the presentation of user interfaces for different applications. More generally, however, the visual interfaces presented on the display need not necessarily be associated with discrete applications, and instead may be associated with different mode of operation of the device, or different menus of the same mode. Thus, for example, upon initiating a communication session, e.g., using a communication application or upon initiating a communication mode, the user may configure the display to present a user interface for a different application or more, for example a game or an Internet browser application, during the communication session. The user may also configure the display to switch back, from the interface associated with some other application, to the communication application or mode interface to enable to the user to manage or terminate the communication session.

Some communication devices include one or more switches for controlling functions and features of the device. The one or more switches are typically coupled to the controller, which may be implemented as one or more discrete digitally programmable controllers or processors or as equivalent analog circuits. Exemplary functions controlled by the one or more switches include power ON/OFF, a volume control, a push-to-talk (PTT), a camera shutter, home button, among others.

Generally, the switches may be mechanical or the switches may be implemented on a touch-sensitive surface of the device. For example, an ON/OFF switch may be embodied as a push button switch and a volume control switch may be implemented as a rotatable rheostat-like controller or a teetering-type input that enables a user to increase and decrease audio output volume. Mechanical switches may take a variety of other forms, all of which are contemplated by the present disclosure. Mechanical switches are perceptible to the user regardless of the state of the display, for example, whether or not the display is illuminated and regardless of the application or mode interface presented on the display.

Touch-activated switches may or may not be perceptible to the user when the display is in the first and second states depending on the particular implementation of the switch. Some touch-activated switches may not be perceptible to a user because a user interface for an application with which the switch is associated is not currently presented on the display. For example, the display may transition to a non-illuminated state to conserve power while the application is running in the background. Alternatively, the display may present a user interface for a different application while the application with which the switch is associated is running in the background.

Other touch-activated switches formed on a user interactive interface of the display may be perceptible regardless of the state of the display by virtue of a visual or tactile indicium formed on the display. In these latter embodiments, backlight from the display is not required to identify the switch, although the switch may be identified by both a backlight and printed or etched or a tactile indicator. Alternatively, a backlight may indicate whether a switch that is otherwise visually delineated is active, if the switch is not always active. Touch sensitive switches may also be located on portions of the device other than the user interactive display. For example, communication devices including the Android operating system currently include several persistently perceptible touch-activated switches for performing Back, Menu, Home, and Search functions. Other devices may have other persistently perceivable touch-activated switches not located on the display per se. In yet another embodiment, a touch-sensitive switch on a portion of the device other than the display interface may also be delineated by a backlight only.

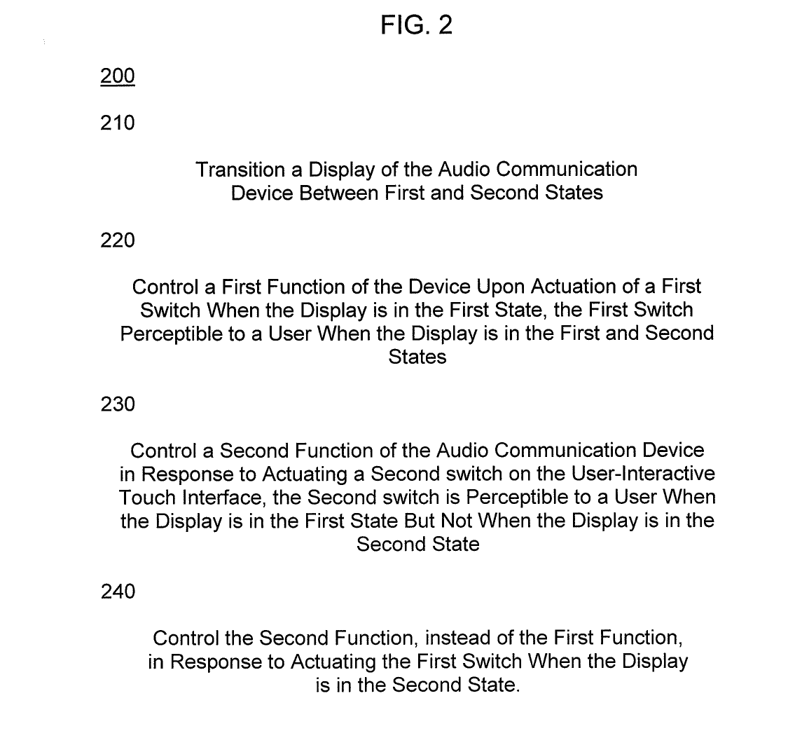

FIG. 2 is a process diagram 200 implemented in a communication device. At 210, a display of the communication device transitions between a first state and a second state. As described above, the display includes a user interactive touch-interface. In FIG. 1, the device includes a first switch 140 coupled to the controller 110, wherein the first switch is perceptible to a user of the communication devices regardless of the state of the display. Examples of switches that are perceptible to a user of the device regardless of the state of the display are described above. The device 100 also includes a second switch 132 disposed on the user-interactive touch interface display. The second switch is perceptible to a user of the communication device when the display is configured in the first state, but the second switch is not perceptible to the user when the display is configured in the second state. As discussed above, this may result from the display being in a non-illuminated state or because some other information is presented on the display.

In FIG. 2, a 220, a first function of the communication device is controlled upon (in other words, in response to) actuation of a first switch when the display is in the first state. The first switch perceptible to a user of the communication devices when the display is in the first state and when the display is in the second state. Examples of switches that are perceptible to the user regardless of the state of the display are described above. In FIG. 1, the controller 110 includes functionality 112 that controls the first function of the communication device upon actuation of the first switch when the display is configured in the first state. The first switch may control most any function of the device, non-limiting examples of which are described herein. For example, the first switch may control ON/OFF power, volume, and various other functions like Home, Back, Menu and Search functions, among many others. The processor may be readily implemented as a digital processor that executes instructions stored in a memory device 150 to perform the control function. Alternatively, the processor may be implemented as an equivalent analog circuit.

In FIG. 2, at 230, a second function of the communication device is controlled upon actuation of a second switch when the display is in the first state. The second switch is perceptible to a user of the communication devices when the display is in the first state but not when the display is in the second state. Thus the user is only able to control the second function using the second switch when the display is in the first state. In FIG. 1, the controller 110 includes functionality 114 that controls the second function of the communication device upon actuation of the second switch when the display is configured in the first state. The second switch may control most any function of the device, non-limiting examples of which are described herein. For example, the functions controlled by the second switch may be associated with an application that runs on the device. In one embodiment, for example, the application is a communication application that includes a touch-activated switch on the user interface that controls an un-mute function. Alternatively the second switch may control mute, volume, speakerphone mode, among various other functions. More generally, the application interface may provide multiple touch-activated switches, each of which controls a corresponding function. The processor may be readily implemented as a digital processor that executes instructions stored in the memory device to perform the control function. Alternatively, the processor may be implemented as an equivalent analog circuit.

In FIG. 2, at 240, the first switch controls the second function, instead of the first function, when the display is in the second state. In FIG. 1, the controller includes functionality 116 that re-assigns the function of the first switch under specified conditions, for example, when the state of the display changes, as described further below. The re-assignment of the function of the first switch is generally temporary. Thus the function performed by the first switch reverts to its original function when the state of the display reverts to its original state. Such a re-assignment could also be conditioned on the actuation of some function, e.g., a function related to the second function. The processor may be readily implemented as a digital processor that executes instructions stored in the memory device to perform the control function. Alternatively, the processor may be implemented as an equivalent analog circuit.

In FIG. 1, the communication device 100 also includes a microphone 144 coupled to the controller. In one particular implementation, the controller is configured to mute the microphone upon actuation of a switch. The microphone may thus be muted during at least a portion of a communication session. In one embodiment, a switch that un-mutes the microphone, i.e., the second switch, is a touch-activated switch on the user interactive display. The microphone may be muted and un-muted by the same switch or by different switches. These one or more switches may be part of a communication application having a visual interface that is presented on the display for managing communications.

Upon changing display states, the un-mute switch is no longer presented on the display. As suggested above, in one embodiment, the display transitions from an illuminated state to a non-illuminated state. In another embodiment, the display changes state by presenting a different user interface. For example, the first state of the display includes presentation of a communication session interface and the second state of the display includes presentation of an interface not including the communication session interface. Under these circumstances, the controller is configured to un-mute the microphone, instead of the control the first function, in response to actuating the first switch. The muting and un-muting of the microphone typically occurs during a communication session. In some embodiments, however, one or both of these functions may be invoked prior to activation of the communication session or after the communication session terminates.

The function performed by the first switch reverts to its original function when the display again changes states, for example, when the user interface presented on the user interactive display includes the switch that un-mutes the microphone. More generally the function of the first switch may revert to its original function upon termination of the application with which the second switch is associated or upon the occurrence of some other event.

In one embodiment, the communication device includes a user perceptible output coupled to the controller, as illustrated at 146 in FIG. 1. The user perceptible output could be implemented as an audible alert, a visual alert, or a tactile alert, or a combination of these alerts. While illustrated as a discrete element it could be integrated with or be a part of the display. In one implementation of the microphone mute/un-mute example discussed above, the controller is configured to cause the user perceptible output to produce a user alert when the microphone is un-muted, thereby alerting the user that the microphone is live or active. Thus when the microphone is un-muted, either by actuating the un-mute switch on the touch-actuated user interactive display or by actuating the re-programmed first switch, the device produces a user perceptible alert.

Alternatively, instead of un-muting the microphone using the re-programmed first switch, the user may un-mute the microphone by configuring the display to present the microphone un-mute switch, i.e., the second switch, and then actuating the un-mute switch from the touch-activated user interactive interface of the display. This alternative however requires the user to perform additional steps or actions that are not required by un-muting the microphone using the first switch with the re-assigned functionality. Thus it is advantageous to control the nu-mute function using the first switch.

In a related implementation, the communication device includes half-duplex push-to-talk (PTT) functionality and the first switch is a PTT switch having a depressible button. The communication session during which it is desired to un-mute the microphone is a full duplex voice communication session. In this implementation, the controller is configured to momentarily un-mute the microphone in response to depressing and maintaining the PTT switch in the depressed state when the display is in the second state (e.g., non-illuminated or not presenting the non-mute switch) during the communication session. Thus instead of actuating a PTT session, the controller re-assigns the function of the PTT to un-mute the microphone when the display is in the second state. Such a re-assignment of the function of the PTT switch could also be conditioned on the actuation of the mute function and the occurrence of a voice call. The function of the PTT switch may revert to its original function upon changing the state of the display such that the un-muted switch is presented, or upon termination of the communication session, or upon termination of the communication session application.

The temporary reassignment of the functionality controlled by a switch on a communication device is not limited to the mute/un-mute function control example, described above. The present invention is applicable to any function that is controlled from a touch-activated user interactive interface of a display wherein the display interface from which the function is normally controlled is not presented to the user, e.g., because the display is in a sleep mode or because the display is presenting a different user interface. Under these circumstances, another switch is temporarily reprogrammed to perform the function controlled by the switch that is not readily accessible to the user.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A communication device comprising:
a controller;
a transceiver coupled to the controller;
a display having a user interactive touch-interface, the display configured to transition between states;
a first switch coupled to the controller, the first switch perceptible to a user of the communication devices regardless of the state of the display, the controller configured to control a first function of the communication device upon actuation of the first switch when the display is in a first state;
a second switch disposed on the user-interactive touch interface, the second switch perceptible to a user of the communication device when the display is configured in the first state, the controller configured control a second function of the communication device upon actuation of the second switch,
the controller configured to control the second function, instead of control the first function, upon actuation of the first switch when the display is in a second state different than the first state, wherein the second switch is not perceptible to a user of the communication device when the display is configured in the second state.

2. The device of claim 1 is a communication handset further comprising
a microphone coupled to the controller,
the controller configured to un-mute the microphone upon actuation of the second switch when the display is in the first state during a communication session,
the controller configured to un-mute the microphone, instead of the control the first function, upon actuation of the first switch when the display is in the second state during the communication session.

3. The device of claim 2, the first state of the display includes presentation of a communication session interface and the second state of the display includes presentation of an interface without presenting the communication session interface.

4. The device of claim 2, the first state of the display is an illuminated state and the second state of the display is a non-illuminated state.

5. The device of claim 2,
the communication session is a full duplex voice communication session,
the communication device includes half-duplex push-to-talk functionality and the first switch is a push-to-talk switch having a depressible button,
the controller configured to momentarily un-mute the microphone upon depressing and maintaining the button of the push-to-talk switch in the depressed state when the display is in the second state during the communication session.

6. The device of claim 2 further comprising a user perceptible output coupled to the controller wherein the controller is configured to cause the user perceptible output to produce a user alert when the microphone is un-muted.

7. The device of claim 1, the first state of the display is an illuminated state and the second state of the display is a non-illuminated state.

8. The device of claim 1, the first switch is a touch activated switch identified by indicium formed on the communication device, wherein the indicium is perceptible to a user of the communication device regardless of the state of the display.

9. A method in a communication device, the method comprising:
transitioning a display of the communication device between a first state and a second state, the display having a user interactive touch-interface;
controlling a first function of the communication device upon actuation of a first switch when the display is in the first state, the first switch perceptible to a user of the communication devices when the display is in the first state and when the display is in the second state;
controlling a second function of the communication device upon actuation of a second switch on the user-interactive touch interface, the second switch perceptible to a user of the communication device when the display is in the first state, the second switch not perceptible to a user of the communication device when the display is in the second state,
controlling the second function, instead of the first function, upon actuation of the first switch when the display is in the second state.

10. The method of claim 9 further comprising
conducting a communication session,
muting a microphone, the microphone muted during at least a portion of the communication session,
un-muting the microphone upon actuation of the second switch when the display is in the first state, and
un-muting the microphone upon actuation of the first switch when the display is in the second state.

11. The method of claim 10, transitioning the display between the first state and the second state includes transitioning the display between an illuminated state and a non-illuminated state.

12. The method of claim 10,
the communication session is a full duplex voice communication session,
the first switch is a half-duplex push-to-talk switch having a depressible button,
momentarily un-muting the microphone upon depressing and maintaining the push-to-talk switch in the depressed state when the display is in the second state during the communication session.

13. The method of claim 10 further comprising producing a user perceptible output when the microphone is un-muted.
